(19) United States
(12) Patent Application Publication
(10) Pub. No.: US 2022/0247577 A1
(43) Pub. Date: Aug. 4, 2022

(54) PROVISIONING SYSTEM AND METHOD

(71) Applicants: Arm Cloud Services Limited, Glasgow (GB); Arm Limited, Cambridge (GB); Arm IP Limited, Cambridge (GB)

(72) Inventors: Alan Christopher Tait, Glasgow (GB); Daniel Bell, Glasgow (GB); Mikko Johannes Saarnivala, Oulu (FI); Marcus Chang, Austin, TX (US)

(73) Assignees: Arm Cloud Services Limited, Glasgow (GB); Arm Limited, Cambridge (GB); Arm IP Limited, Cambridge (GB)

(21) Appl. No.: 17/162,686

(22) Filed: Jan. 29, 2021

(51) Int. Cl. H04L 9/32

(52) U.S. Cl. CPC H04L 9/3268

(57) ABSTRACT

A method of provisioning a device to use a data service provided by a data service provider comprises maintaining a list of unique identifiers of devices to which a trusted certificate has been issued and receiving a data service request for a device. The request will include a unique identifier for the device and a certificate. In response to the data service request, the list of device unique identifiers is consulted in order to verify that the certificate contained in the data service request is a trusted certificate. If the certificate contained in the service request is a trusted certificate, the certificate may then be forwarded to the data service provider.

The present application relates to a system and method for provisioning a device to conduct data sessions on a network such as but not limited to a mobile or other wireless network.

### BACKGROUND

There is an increasing interest in the equipping of devices with wireless data connections. These wireless data connections can then be used, for example, to establish data sessions with a remote server for the reporting of data by the devices and sending of data and instructions to the devices. Such wireless connected devices are commonly referred to as Internet of Things “IoT” devices (although they need not use the internet for communication), and their connectivity may also be referred to as machine to machine (M2M) communication. Typically, the wireless data connections are provided by providing subscriber identify modules “SIMs” in the individual devices. SIMs are available in various forms and usually use Universal Integrated Circuit Card “UICC” technology. Examples include the well-known SIM card which has evolved over shrinking form factors “FFs” from the original 1 FF to 4FF (the nano SIM) which is inserted into a device. Other examples are embedded into a device, for example using embedded universal integrated circuit card “eUICC” technology, such as the eSIM, QFN8 and M2MFF or integrated into a device such as the iSIM which comprises eUICC software that runs in a dedicated enclave in a system-on-chip (SoC) to provide remote SIM provisioning capability. The systems and methods described here are not limited to the use of SIMs or UICC technology and other forms of device identification are possible.

Devices with M2M or IoT connectivity are commonly electronic devices comprising one or more sensors, but in principle this connectivity can be provided to any device or object.

The connectivity of such devices need not be mobile. They may for example communicate via Wi-Fi or any other form of wireless connection. In order to equip devices with mobile wireless connectivity, for example to provide desired M2M or IoT functionality, it is necessary to provision IOT devices, for example via their SIMs, to allow them to access the different wireless networks operated by various Mobile Network Operators (MNOs).

The term “provisioning” is commonly used in this art. It is used in this document to refer to enabling a device to use a particular service, including but not limited to a connectivity service such as that provided by a mobile network operator, and a device management or any other service in which a data session is established between a device and a server using a connectivity service, referred to here as a data service and sometimes also known as a cloud service. Provisioning may involve registering a device with a service and need not require any modification of the device itself. In some examples provisioning may involve downloading to a device a profile specific to the service. For example, where the service is wireless connectivity, the service might be limited to a geographical area, an amount of data, or be subject to other constraints, which can be managed by the provider of the wireless connectivity or by a third party device management service. Other examples of provisioning will be apparent to those skilled in this art.

Manufacturers of products incorporating IoT devices, who will typically deploy large numbers of SIMs, generally use the services of Connectivity Management Platforms (CMP) to manage their relationships with the MNOs on their behalf, in order to reduce complexity and expedite time to market for devices.

A number of different Connectivity Management Platforms (CMP) exist, offering various integration approaches to control the process of provisioning devices in order to enable the devices to access the different wireless networks operated by the various MNOs. CMP services may be provided alongside other services. Therefore references here to “CMP” are not limited to stand-alone CMPs and include CMP services provided in any form. For example a mobile virtual network operator (MVNO) may provide a CMP service.

This wireless connectivity may be used for example to enable devices to communicate with data service providers. For example a device in a vehicle may communicate with a location data service. Some such services require devices to register with them and or be authenticated, for example using a certificate. Therefore a device may need to be provisioned to use a service. Some devices are designed such that they are not able to function as required until they are registered with a service.

There is a therefore a need for systems and methods that enable devices to be registered with service providers as quickly and simply as possible.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one aspect there is provided in the following a method of provisioning a device to use a data service provided by a data service provider. The method comprises maintaining a list of unique identifiers of devices to which a trusted certificate has been issued, and receiving a data service request from a device. The request will include a unique identifier for the device and a certificate. In response to the data service request, the list of device unique identifiers is consulted in order to verify that the certificate contained in the data service request is a trusted certificate. If the certificate contained in the service request is a trusted certificate, the certificate may then be forwarded to the data service provider.

The list may provide a mapping of device unique identifiers to certificates. The certificate may be used to authenticate the device to the data service provider, following which the data service provided can communicate directly with the device.

Thus whereas a CMP may provision a device to use services of a MNO, a third party platform may provision a device to use a data service. This method avoids the need for the data service provider to consult a certificate authority in order to authenticate the device requesting its services. The method may be performed at a CMP or at a platform which includes a CMP.

Methods according to some aspects may be implemented in a computing device such as a server. Thus in another aspect there is also provided a server comprising a processor and memory and configured to implement the methods described here. A server operating in this way may perform the function of a certification authority.

In another aspect, the present disclosure provides a computer readable medium comprising instructions which when executed in a processor in a computing system cause the system to perform any of the methods described here.

The methods described herein may be performed by software in machine readable form, for example but not limited to on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Features described in the following may be combined as appropriate, as would be apparent to a skilled person, and may be combined with any of the aspects.

### BRIEF DESCRIPTION OF THE DRAWINGS

Embodiments will be described, by way of example, with reference to the following drawings, in which:

FIG. 1 is a schematic diagram of an embodiment of a system according to some embodiments;

FIG. 2 is a schematic diagram of an embodiment of a system showing message flows between components;

FIG. 3 is a sequence diagram showing message flows according to some embodiments of the system and method;

FIG. 4 is a flow chart illustrating a method of installing certificates on SIMs according to some embodiments of the system and method.

Common reference numerals are used throughout the figures to indicate similar features.

### DETAILED DESCRIPTION

Embodiments of the system and method are described below by way of example only. These examples represent the best ways of putting the system and method into practice that are currently known to the applicant although they are not the only ways in which this could be achieved. The description sets forth the functions of the examples and the sequence of steps for constructing and operating the examples. However, the same or equivalent functions and sequences may be accomplished by different examples.

In the following embodiments, the unique identifier identifies a SIM, and the provisioning of a device comprises provisioning the SIM. However as noted above methods and systems described here are not limited to the use of SIMs and other forms of uniquely identifying devices may be used.

IoT devices are used in all kinds of products. Examples include cars, robotic lawn mowers and smart refrigerators. Many other examples will be known to those familiar with this art. In the IoT device market it is typical for a product manufacturer to purchase SIMs for use in their products, or IoT devices already provided with SIMs, in bulk. Such manufacturers are referred to here as “customers”. The purchaser of a product incorporating an IoT device is referred to as a “user” or “end user”. A product may comprise more than one IoT device. Customers will typically subscribe to IoT device services such as but not limited to connectivity management platforms to manage network connectivity and data services such as device management platforms to perform data services such as reporting mileage, product health status (e.g. in case replacement of parts is required) and other sensor information. Therefore customers are also referred to as “subscribers” and may have multiple subscriptions, for example one for each device or group of devices.

It should be noted here that a trusted certificate may serve as an additional form of identity for a device. For example it may signify that the device has been issued to a particular customer.

The term “platform” is used here to refer to any hardware or software used to host an application or service. Thus for example a platform may take the form of a computing system such as a computing system configured as a server.

The provisioning of a SIM may be instigated by a subscriber, for example when a product containing a device containing a SIM is sold, or by the end user.

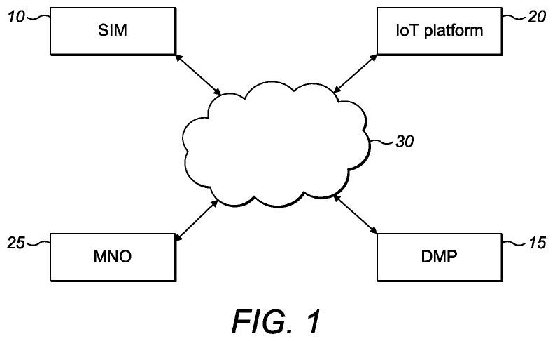

Some components of a system, in which the methods described here may be implemented, are illustrated schematically in FIG. 1. A SIM 10 may be provisioned to use a data service such as a device management platform “DMP” 15. Embodiments are not limited to device management and may be used in provisioning devices to use any kind of data service. This may be facilitated by a platform 20, referred to here as an IoT platform. The SIM 10 and the platforms 20, 15 may communicate with each other via communication network 30 which may comprise any suitable means including wired and wireless connection. In addition the SIM 10 may be provisioned to use the services of a MNO 25 and for this purpose the IoT platform may comprise a CMP.

Only one DMP15 is shown in the figures for the sake of clarity. However embodiments described here may be used to provision a SIM 10 to enable a device to use a plurality of different data services not limited to device management. Similarly, only one MNO 25 is shown in the figures for the sake of clarity but it will be appreciated that a CMP, for example provided as part of the IoT platform 20, may provision a device to communicate via one or more of a plurality of mobile networks. The IoT 20 platform may view each SIM 10 as a globally unique object, for example in order to allow IoT devices and their associated SIMs 10 to be correctly associated with different selected services of a DMP 15, or different tariffs from different MNOs irrespective of the network technology used.

As is well known, each SIM 10 has a unique Integrated Circuit Card Identifier (ICCID). The unique ICCID may be assigned at the point of manufacture of the SIM 10 and may be provided from a global pool of ICCIDs assigned to a CMP, or to the IoT platform 20 as a whole, or to the organization operating the IoT platform 20. This unique ICCID may then be used as a master record by the IoT platform to uniquely identify the SIM 10 in all subsequent interactions with the IoT platform 20.

Accordingly, if a customer requires a SIM 10 to be provided for incorporation into a customer IoT device the customer can request issue of the SIM 10 and the IoT platform 20 may automatically assign a suitable SIM 10 controlled by the IoT platform 20 to the customer and provide the corresponding assigned ICCID.

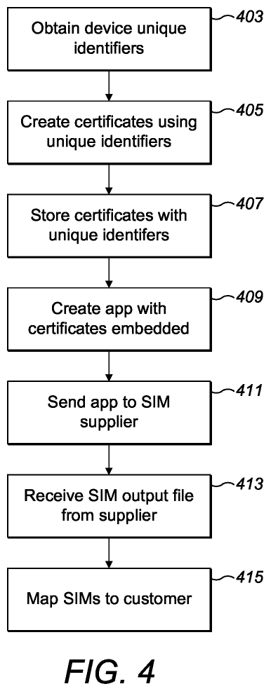

According to some embodiments, a certificate is installed in the SIM 10 prior to the SIM being issued to a customer. The installation of the certificate may be performed under the control of the organization operating the IoT platform 20 in a manner to be described below with reference to FIG. 4.

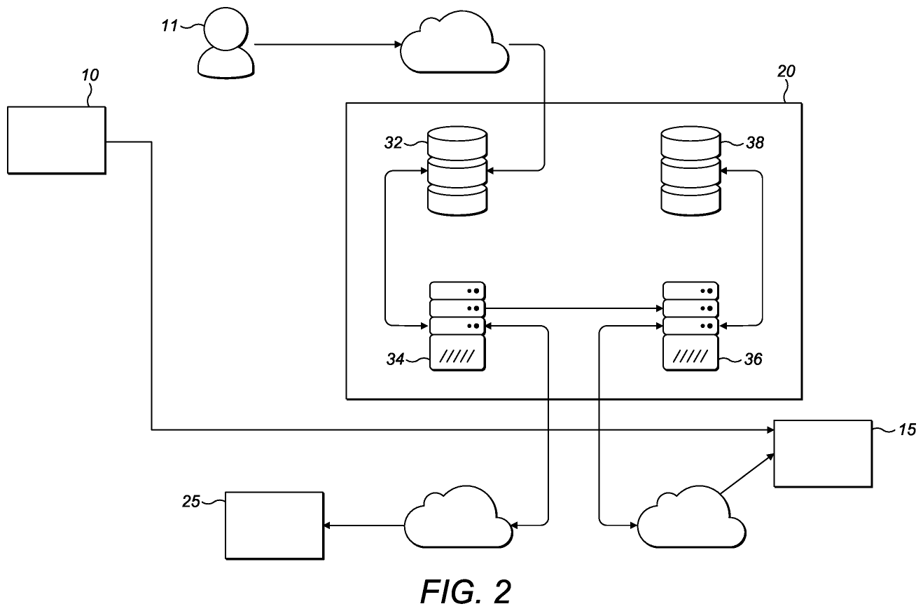

The functions of the IoT platform 20 are explained in more detail with reference to FIG. 2.

The IoT platform 20 offers M2M or IoT services to subscribers, including provisioning SIMs 10 to use data services and optionally mobile network connectivity management. An example of a CMP, which may form part of the IoT platform 20, is described in our earlier patent application GB2571294A1. Embodiments described here may be used in conjunction with the systems and methods described in that patent application.

The IoT platform 20 shown in FIG. 2 may be configured to receive and act on requests received via a SIM for one or more IoT services including but not limited to device management services provided by DMP 15 and mobile connectivity services provided by MNO 25. This is commonly known as “activating” the SIM 10.

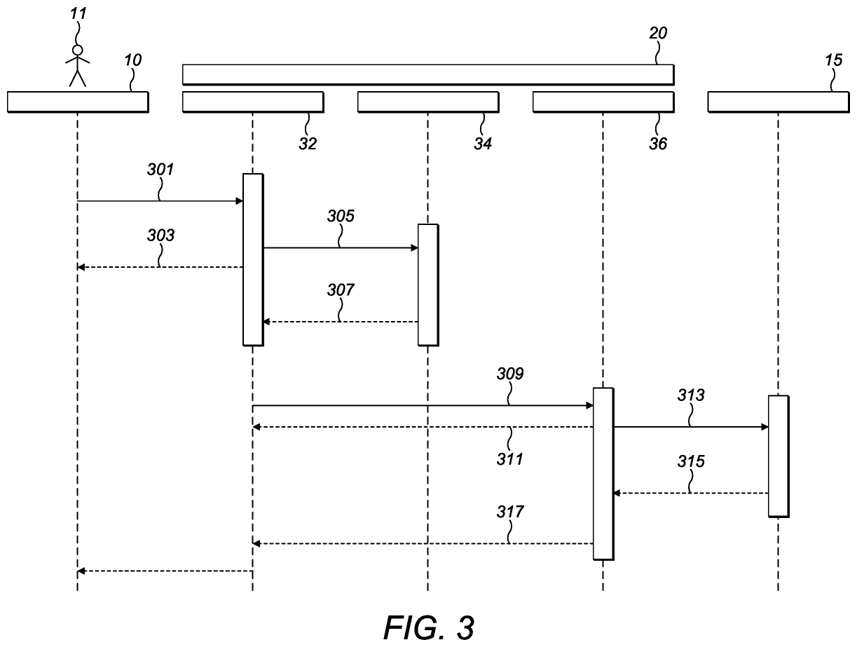

The IoT platform 20 is shown to include a number of components including a first data store serving as a request queue 32 at which requests may be buffered or held in a queue, a network provisioning service “NPS” 34 providing an interface between the IoT platform 20 and the MNO 25, a DMP provisioning service 36 providing an interface between the IoT platform 20 and the DMP 15, and a second data store serving as a certificate store 38. Message flows between these components are shown in FIG. 3.

Prior to commencement of a method according to some embodiments, information is loaded into the certificate store 38 for use in authenticating the SIM. For example, a list of unique identifiers of devices, e.g. SIMs to which a trusted certificate has been issued, may be stored in the certificate store 38. The certificates themselves may also be stored here so that the certificates are mapped to the unique identifiers. The unique identifiers may be in any suitable format and may comprise a primary identifier of a subscription to the IoT 20 platform or the DMP, which may be for example ICCIDs, or if mobile connectivity is required they may comprise the International Mobile Subscriber Identities “IMSIs”. In some embodiments the device unique identifier may comprise a Mobile Station International Subscriber Directory Number “MSISDN”.

The SIM 10 may be a “dumb” device and may for example attempt to communicate directly with the DMP 15 as soon as it has power, at predetermined time intervals. The DMP 15 may be configured not to accept data transmitted to it from the SIM 10 until the SIM has been activated. The activation may be initiated by a user 11 via an interface with the IoT platform 20 or DMP provisioning service 36, for example via equipment such as a user computing device not shown, or via an application programming interface “API” as is known in the art. To avoid the user having to manually input details of the SIM 10 such as its identity or certificate, the user 11 may arrange for the SIM 10 or device in which it is contained to communicate with the user computing device, for example via wired or short range wireless connection such as Bluetooth.

The message flow of FIG. 3 commences with a request 301 to activate the SIM 10, transmitted in this embodiment from the user 11 computing device to the IoT platform 20 where it is received. The request may include the unique identifier of the SIM 10 and the certificate which has been installed on the SIM, extracted by from the SIM 10 by software on the user's computing device or the IoT platform. The request may include other metadata or information, for example an identifier of a subscription to a device server from which services are requested, any of which information may have been installed in the SIM at the time of manufacture. In other words the activation request, or request for services, may include some kind of identifier of services for which it is provisioned, for example in case the IoT platform is able to provision SIMs for various different services.

The request may be to use a data service and optionally a mobile network. The IoT platform 20 may, in response to the request, consult the list of device unique identifiers in the certificate store 38 in order to verify that the certificate contained in the data service request is a trusted certificate. If the certificate contained in the service request is a trusted certificate, the IoT platform 20 may then forward the certificate to the data service provider, e.g. DMP 15. This process may be carried out in a number of different ways within the IoT platform 20, some of which are described below. Once the DMP has the SIM certificate, the DMP 15 may communicate directly with the SIM 10, or the device containing the SIM 10.

In the illustrated embodiments shown in FIGS. 2 and 3 it is assumed that the activation request is to use a data service and a mobile network, although as noted elsewhere methods and systems described here can be used to provision a SIM for data services only, for example where mobile connectivity is not required.

In the embodiment shown in FIGS. 2 and 3, a request 301 to activate the SIM 10 is transmitted from end user 11 equipment to the IoT platform 20, for example the end user equipment may comprise a computer. The request may be transmitted via an application programming interface “API” or web user interface “UI”. This request 301 contains the SIM 10 unique identifier and the certificate. The certificate may take any form known in the art of authentication. Examples of certificate types include but are not limited to public/private key pairs, for example complying with the X509 standard. The activation message may be received at the request queue 32 in the IoT platform 20 where it is examined and a success/fail response is transmitted back to the user 11 equipment as indicated by message 303. This message 303 indicates whether or not the request will be processed. A fail state may occur before a request queue message is created within request queue 32. For example the IoT platform may perform validation logic on details provided to it by the end user via an API or web UI. A fail response might result if the request 301 is initially found to be incorrect. For example in the case of provisioning with an MNO, an end user could be requesting activation of a SIM that is not in their account with the MNO or to activate it on a rate-plan or tariff or pricing scheme that is not appropriate to their account. There could also be internal errors in the IoT Platform 20 itself such as not being able to communicate with the certificate store, request queue or other data stores and internal services required for the purpose of activating a SIM.

If the initial request 303 was successful, according to the flow shown in FIGS. 2 and 3, the request is forwarded to the NPS 34 as indicated by message 305. At this stage the SIM 10 may be provisioned to use a mobile network by any suitable process, for example as described in GB2571294A1. The NPS responds with a message indicating whether the network provisioning was successful, as indicated by message 307.

The next message in the flow of FIG. 3 is the forwarding of the activation request from the request queue 32 to the DMP provisioning service 36 as indicated by message 309. In the flow shown in FIG. 3 the activation request is forwarded to the DMP provisioning service 36 after the network provisioning has taken place. This is not essential if mobile network connectivity is not required, as will be explained further below.

FIG. 2 shows an alternative message flow in which the NPS 34 forwards the certificate to the DMP provisioning service 36 after MNO provisioning, instead of returning a success/fail message for the request queue to forward the activation request to the DMP provisioning service 36. Other alternative message flows are possible in order to achieve the same end result.

The DMP provisioning service 36 authenticates the SIM 10 by a process to be described by reference to FIG. 2. It may return a fail message 311 to the request queue if the SIM is not authenticated. Message 311 is not essential and according to some embodiments message 309 may be created only if message 307 indicated success. In other words in such an embodiment there would be no case where a SIM would not be authenticated when it is handled by the DMP provisioning service 36. If the SIM is authenticated, the certificate received in the activation request is forwarded to the DMP 15 in message 313. The DMP 15 will return a success/fail message 315 in response to which the DMP provisioning service 36 at the IoT platform 20 will return a success/fail message to the request queue 32. Possible causes of a fail message may include certificate in use/already registered, invalid identity and others. In the event of success, at this point the SIM is registered with the DMP and the DMP 15 may then commence accepting data that is being sent to it by the SIM 10.

The SIM 10 and the DMP 15 may communicate using any suitable communication protocol such as but not limited to lightweight M2M.

As is known with IoT device communication, in the meantime the SIM 10 may attempt to send data to the DMP 15 from the time of sending the activation request. Therefore a confirmation message back to the SIM 10 to enable it to begin communicating with the DMP 15 is not required.

As shown in FIG. 3, message 309 is sent from the request queue 32 to the DMP provisioning service 36 to activate the SIM 10 for services of the DMP 15. Alternatively as shown in FIG. 2 the request to activate the SIM 10 for DMP 15 services may be sent to the DMP provisioning service 36 via the NPS 34.

The authentication process performed by the DMP provisioning service 36 in response to message 309 will now be described with reference to FIG. 2. Regardless of how the DMP provisioning service 36 receives a request for services, it then initiates consultation of the list of device unique identifiers in order to verify that the certificate contained in the data service request is a trusted certificate, for example by comparing the received identifier with identifiers in the certificate store 38 to find a match. For additional security in some embodiments, the certificates issued in connection with device unique identifiers are also stored in the certificate store 38. Then not only the device unique identifier but also the certificate are compared with identifiers and certificates in the certificate store to find a match. If a match is found, confirmation is sent from the certificate store 38 to the DMP provisioning service 36. Alternatively, the device unique identifier may be transmitted to the certificate store 38, the certificate store 38 may return the issued certificate, and this may be compared at the DMP provisioning service 36 in order to authenticate the SIM, in other words verify that the received certificate is a trusted certificate, for example one that was previously issued for use with the device unique identifier.

If it is verified that the certificate is a trusted certificate, the DMP provisioning service 36 may then forward the certificate to the DMP 15, for example in message 313 shown in FIG. 3.

It will be appreciated from the foregoing that in general a data service request, e.g. activation request, may be received prior to the device being provisioned to a communications network and a method according to some embodiments may comprise provisioning the device to use a communications network in response to the data service request.

The message flow shown in FIG. 3 may readily be modified if mobile connectivity is not required, for example if the device is able to communicate with the DMP 15 via another communication medium such as Wi-Fi. In that case message flows 305 and 307 may be omitted and authentication of the device to use a data service may commence in response to receipt of a request for the service, e.g. an activation request 301.

Alternatively if mobile connectivity is required but not essential, provisioning the device to use the mobile network may be conducted in parallel with provisioning a device to use the data service.

In some possible implementations, where mobile connectivity is not required or available, it may be necessary for a device to register with a communication service before it can be used. Therefore an IoT platform may provision a device to use any non-mobile or non-cellular communication network, or a fixed location communication network, instead of or in addition to the NPS shown in the figures.

As noted elsewhere here, the trusted certificate may serve as an additional form of identity for the device. For example it may signify that the device has been issued to a particular customer. According to some embodiments, transport layer security may be used in the authentication and the certificate may comprise part of a private/public key pair, usually the public key. Both public and private keys may be loaded onto the SIM 10 and the certificate stored at the certificate store 38 may be only the public key of the public/private pair. The initial message 301 may include the public keys, and the certificate fetched from the certificate store 38 and forwarded to the DMP 15 in message 313 may be the same public key. In other words, message 313 only contains the public key from certificate store 38 and will always be the same as the public key on SIM 10 The certificate may serve as a credential for the SIM 10 which is issued to the DMP 15 by the IoT platform 20.

It will be appreciated from the foregoing that in a similar manner to the network provisioning described in our earlier patent application GB2571294A1, a device may be provisioned to use a data service and optionally also a mobile network in response to an activation instruction which may for example comprise a single click on an “activate” option on a customer interface of the IoT platform 20. Notably the user does not need any knowledge of the certificate itself. In this respect the authentication of the SIM may be completely invisible to the user.

The process of installing the certificates in the SIMs may take place in any number of ways. A possible process is now described with reference to FIG. 4. By way of background SIMs may be produced using a custom application which allows the loading of certificates to the SIMs, for example from a series of well-known “attention” or “AT” commands. The application may be used by a SIM manufacturer, or by another party that loads data to blank SIMs.

The process of FIG. 4 begins with operation 403 where a range of unique identifiers, e.g. ICCIDs is obtained in any manner known in the art. For example, each MNO may be given a range of ICCIDs according to the relevant standard. The ICCIDs may have associated IMSIs and other identifiers as is known in mobile wireless communications. At operation 405, certificates are created using the obtained unique identifiers. In the case where the certificates comprise public keys, the public/private key pairs may be created at this stage. The certificates may be created on a one certificate to one identifier basis, or one to many. At operation 407 the certificates, e.g. public keys, and unique identities, e.g. ICCIDs, are stored in a certificate store, e.g. store 38 of FIG. 3. At operation 409 the application is created with the certificates embedded. This may then be provided to the SIM supplier at operation 411, for example as an input file to the SIM supplier containing the unique identifier as well as a binary large object “blob” of the application containing the certificates.

At operation 413 the SIM supplier may supply a SIM output file which may then be loaded to the IoT platform 20. Among other things this will confirm which of the previously certificates have been loaded to SIMs. Then at operation 415 SIMs may be mapped to customers, for example on a 1:N basis, e.g. many SIMs to one customer.

It should be noted here that it is not necessary for certificates to be allocated to SIMs on a one to one basis. Some services, or customers for services, may not require SIMs to be authenticated at an individual level. Therefore, depending on the level of granularity required by a service or customer, it is possible according to some embodiments for the same certificate to be installed on a group of SIMs. For example in the flow of FIG. 4 there could be a one-to-many relationship between blobs and SIMs. Usually the group of SIMs would be associated with the same customer.

It is not essential for the IoT platform 20 to act as a certification authority “CA”. For example the IoT platform 20 could operate as an intermediary for a CA by receiving the public keys and corresponding unique identifiers, and any other necessary information, from a third party and storing them in the certificate store 38 in order to provision SIMs controlled by the third party to use the services of the DMP 15.

As noted elsewhere here the certificate may take any form including but not limited to an X509 certificate. According to some embodiments the certificate may comprise a so-called intermediate certificate, which may form part of a certificate chain, such as those issued by Comodo Certification Authority “Comodo CA”.

It will be appreciated from the foregoing that in a similar manner to the network provisioning described in our earlier patent application GB2571294A1, embodiments of the invention may avoid the need for certificates to be pre-allocated to customers. For example, the certificates created and stored at operations 405 and 407 need not be associated by the IoT platform with customers and can be allocated to customers after operation 409, for example in response to a request from a customer to a batch of SIMs, either with the same certificates or with different certificates. In other words the mapping of SIMs to customers at operation 415 may take place at any time between storing the certificates at operation 407 and the initial request to activate the SIM 301 in FIG. 3.

The embodiments described above are fully automatic. In some alternative examples a user or operator of the system may instruct some steps of the methods described here to be carried out.

In the illustrated embodiment the modules of the system are defined in software. In other examples the modules may be defined wholly or in part in hardware, for example by dedicated electronic circuits.

In the described embodiments the system may be implemented as any form of a computing and/or electronic device.

Any of the system components shown in the figures may be combined and implemented at a single device unless otherwise stated, or distributed over a number of physically separated computing devices, as is known in the art.

Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The computer executable instructions may be provided using any computer-readable media that is accessible by computing based device. Computer-readable media may include, for example, computer storage media such as a memory and communications media.

Computer storage media, such as a memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media.

Although the system is shown as a single device it will be appreciated that this system may be distributed or located remotely and accessed via a network or other communication link (e.g. using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art.

Although various embodiments have been described above with a certain degree of particularity, or with reference to one or more individual embodiments, those skilled in the art could make numerous alterations to the disclosed embodiments.

Aspects of this disclosure are set out in the following numbered clauses:

1. A method of provisioning a device to use a data service provided by a data service provider, the method comprising:

maintaining a list of unique identifiers of devices to which a trusted certificate has been issued;

receiving a data service request for a device, wherein the request includes a unique identifier for the device and a certificate;

in response to the data service request, consulting the list of device unique identifiers in order to verify that the certificate contained in the data service request is a trusted certificate;

if the certificate contained in the service request is a trusted certificate, forwarding the certificate to the data service provider.

2. The method of clause 1 wherein the unique identifier identifies a SIM and the method comprises issuing trusted certificates to multiple SIMs prior to the SIMs being issued to users.
3. The method of clause 1 or clause 2 wherein maintaining the list of unique identifiers comprises storing each unique identifier in memory together with the trusted certificate issued to it.
4. The method of clause 3 wherein consulting the list of device unique identifiers comprises comparing the received certificate with the stored trusted certificate.
5. The method of any preceding clause wherein the data service request is received prior to the device being provisioned to a mobile communications network and further comprising provisioning the device to use a communications network in response to the data service request.
6. The method of clause 5 comprising provisioning the device to use the mobile communications network in parallel with provisioning the device to use the data service.
7. The method of any preceding clause wherein the certificate comprises the public key of a public/private key pair.
8. The method of any preceding clause comprising obtaining a plurality of device unique identifiers and creating the certificates using the device unique identifiers.
9. The method of any preceding clause wherein the unique identifiers of devices comprise one of Integrated Circuit Card Identifiers “ICCIDs”, International Mobile Subscriber Identities “IMSIs” and Mobile Station International Subscriber Directory Numbers “MSISDNs”.
10. A server comprising a processor and memory and configured to implement the method of any of clauses 1 to 8.
11. A computer readable medium comprising instructions which, when executed in one or more processors in a computing system, cause the system to perform the method of any of clauses 1 to 8.

1. A method of provisioning a device to use a data service provided by a data service provider, the method comprising:
maintaining a list of unique identifiers of devices to which a trusted certificate has been issued;
receiving a data service request for a device, wherein the request includes a unique identifier for the device and a certificate;
in response to the data service request, consulting the list of device unique identifiers in order to verify that the certificate contained in the data service request is a trusted certificate;
if the certificate contained in the service request is a trusted certificate, forwarding the certificate to the data service provider.

2. The method of claim 1 wherein the unique identifier identifies a SIM and the method comprises issuing trusted certificates to multiple SIMs prior to the SIMs being issued to users.

3. The method of claim 1 wherein maintaining the list of unique identifiers comprises storing each unique identifier in memory together with the trusted certificate issued to it.

4. The method of claim 3 wherein consulting the list of device unique identifiers comprises comparing the received certificate with the stored trusted certificate.

5. The method of claim 1 wherein the data service request is received prior to the device being provisioned to a mobile communications network and further comprising provisioning the device to use a communications network in response to the data service request.

6. The method of claim 5 comprising provisioning the device to use the mobile communications network in parallel with provisioning the device to use the data service.

7. The method of claim 1 wherein the certificate comprises the public key of a public/private key pair.

8. The method of claim 1 comprising obtaining a plurality of device unique identifiers and creating the certificates using the device unique identifiers.

9. The method of claim 1 wherein the unique identifiers of devices comprise one of Integrated Circuit Card Identifiers “ICCIDs”, International Mobile Subscriber Identities “IMSIs” and Mobile Station International Subscriber Directory Numbers “MSISDNs”.

10. A server comprising a processor and memory and configured to implement the method of claim 1.

11. A computer readable medium comprising instructions which, when executed in one or more processors in a computing system, cause the system to perform the method of claim 1.
